(19) United States
(12) Patent Application Publication
(10) Pub. No.: US 2024/0140057 A1
(43) Pub. Date: May 2, 2024

(54) ADHESIVE SEALANT FORMULATION FOR TIRES

(71) Applicant: ZUCCHINI INNOVAZIONE S.R.L., Ferrara (FE) (IT)

(72) Inventor: Gianfranco MASCELLANI, Ferrara (IT)

(73) Assignee: ZUCCHINI INNOVAZIONE S.R.L., Ferrara (FE) (IT)

(21) Appl. No.: 18/548,748

(22) PCT Filed: Mar. 2, 2022
(86) PCT No.: PCT/IT2022/050041

§ 371 Date: Sep. 1, 2023

(30) Foreign Application Priority Data
Mar. 2, 2021 (IT) 102021000004847

(51) Int. Cl. B29C 73/16; B29C 73/22; B29D 30/06; B60C 19/00; B60C 19/12; C09J 5/02; C09J 5/06; C09J 201/00

(52) U.S. Cl. CPC B29C 73/163; B29C 73/22; B29D 30/0685; B60C 19/002; B60C 19/122; C09J 5/02; C09J 5/06; C09J 201/00; B29D 2030/0682; B29D 2030/0697; B29K 2995/0002; C09J 2400/22; C09J 2409/00; C09J 2421/008; C09J 2453/00; C09J 2493/00

(57) ABSTRACT

An adhesive sealant formulation for tires includes: from 20% to 35% by weight of the total formulation of block copolymers, from 55% to 75% by weight of the total formulation of resins, from 0.2% up to 2.0% by weight of the total formulation of a mixture of stabilizers and antioxidants, where the quantity of stabilizers within the mixture varies from 0 up to a maximum 1.50% by weight of the total formulation and the amount of antioxidants varies from 0 up to a maximum of 1.50% by weight of the total formulation, such as in particular: primary phenolic pentaerythritol-tetrakis(3(3,5-di-tert-butyl-4-hydroxyphenyl)propionate); from a minimum of 5% to a maximum of 35% by weight of the total formulation of paraffinic or naphthenic plasticizers; from a minimum of 2% up to a maximum of 5% by weight of the total formulation of mineral fillers.

The present invention relates to an adhesive sealant formulation for tires.

In particular, the invention refers to an adhesive sealant formulation, for sealing the punctures in tires without an inner tube, hereinafter also referred to as tubeless tires.

It is known that tubeless tires are generally considered to be relatively safe against punctures, because even when an object, such as a nail, penetrates through a tubeless tire generating a hole, the material from which the tire is made tends to tighten around the nail, with the consequence that the nail remains tight in the hole and cannot come out easily and that the hole is completely taken up by the nail, so the air does not escape quickly. However, when a tubeless tire where a nail has entered is used for a long period of time, especially at high speed, the nail tends to come out due to centrifugal force and once the nail has come out, the air escapes quickly through the free hole.

Therefore, in order to keep a car in conditions of safety, it is important that, even when a nail that has penetrated through a tire comes out freeing the hole, the tire must be kept in a condition in which that hole does not allow the passage of the air contained in the tire.

To solve this problem, according to the prior art, tires for vehicles provided with a layer of sealing material, arranged inside the tire at the time of manufacturing, on the internal surface in projection of the tread, have been proposed. The application can take place in particular in the steps preceding the vulcanization, to ensure a better coupling between the tire and the layer of sealing material. The sealing material has a viscosity and adhesiveness such that, in the event of a puncture in the tread, with the expulsion of the object that caused the puncture, the sealant flows into the channel left behind and seals it hermetically.

In particular, a self-sealing tire is described in US 2016/001611 and a material for increasing the safety of a tire is described in CN 112 280 233.

According to the Applicant, one of the major problems encountered in the self-sealing tires is finding a correct combination of properties for the sealing material used. In fact, said material must be able to flow rapidly towards the puncture, adhere to the object that caused the puncture and not come out of the puncture, in order to avoid the loss of air and the consequent deflation of the tire. In addition, the sealing material must maintain its position inside the tire when the vehicle is stationary or during storage. On the other hand, when the tire is moved, which could create non-uniformities in the distribution of the sealing material, said sealing material must be able to be rearranged quickly and uniformly inside the tire. In fact, a displacement of the sealing material from its original position and its accumulation in other areas of the tire would not only cause a loss of balance in the weight distribution inside the tire, but would also make its use ineffective as a sealing layer, or would give the tire at least one unsatisfactory self-sealing capacity.

Another important limitation of the sealing materials according to the prior art is that they include volatile components, which during the application in the tire can evaporate, compromising the healthiness of the manufacturing environments.

Finally, it is desirable that the sealing material is applicable to the tire subsequently to the manufacturing of the tire itself, in particular to make a tire of traditional type self-sealing.

The solution according to the present invention fits into this context, aiming to provide an adhesive sealant formulation for tires whose composition is optimized to have a satisfactory behaviour in a wide range of temperature, as well as to facilitate its application on finished tires, using systems already available on the market, such as in particular hot melt adhesive extruders (Hot Melt type), and guaranteeing the maximum safety and healthiness of the working environment.

These and other results are obtained according to the present invention by proposing an adhesive sealant formulation applicable to all tubeless tires.

The aim of the present invention is therefore to provide an adhesive sealant formulation for tires which allows to overcome the limitations of the formulations according to the prior art and to obtain the technical results previously described.

A further aim of the invention is that said adhesive sealant formulation for tires can be realized and applied with substantially contained costs, both in terms of manufacturing costs and application costs.

Last but not the least, a further aim of the invention is to propose an adhesive sealant formulation for tires that is safe and reliable.

A first specific object of the present invention is therefore an adhesive sealant formulation for tires consisting of:
from a minimum of 20% to a maximum of 35% by weight of the total formulation of block copolymers chosen from: polyisobutadiene (PIB), styrene-isoprene-styrene (SIS), styrene-butadiene-styrene (SBS), styrene-isoprene-butadiene-styrene (SIBS), styrene-ethylene-butadiene-styrene (SEBS), styrene-ethylene-propylene-styrene (SEPS), thermoplastic elastomers (TPE);
from a minimum of 55% to a maximum of 75% by weight of the total formulation of resins chosen from: rosin resins, esterified rosin resins and other rosin derivatives, hydrocarbon resins, hydrogenated cycloaliphatic hydrocarbon resins, phenolic resins, styrene resins, or mixtures thereof;
from a minimum of 0.2% up to a maximum of 2.0% by weight of the total formulation of a mixture of stabilizers and antioxidants, wherein the quantity of stabilizers within the mixture varies from 0 up to a maximum of 1.50% by weight of the total formulation and the amount of antioxidants varies from 0 up to a maximum of 1.50% by weight of the total formulation, such as in particular: primary phenolics pentaerythritol-tetrakis(3(3,5-di-tert-butyl-4-hydroxyphenyl)propionate);
from a minimum of 5% to a maximum of 35% by weight of the total formulation of paraffinic or naphthenic plasticizers;
from a minimum of 2% up to a maximum of 5% by weight of the total formulation of mineral fillers such as in particular: silica, carbon black, graphite.

Preferably, according to the present invention, the melting temperature of the entire mass of the complete formulation is comprised between a minimum of 160° C. and a maximum of 180° C.

A second specific object of the present invention is also a method for producing an adhesive sealant formulation for tires as previously defined, characterized in that the following components are hot mixed, at a temperature between 160° C. and 180° C. and under vacuum:
from a minimum of 20% to a maximum of 35% by weight of the total formulation of block copolymers chosen from: polyisobutadiene (PIB), styrene-isoprene-styrene (SIS), styrene-butadiene-styrene (SBS), styrene-isoprene-butadiene-styrene (SIBS), styrene-ethylene-butadiene-styrene (SEBS), styrene-ethylene-propylene-styrene (SEPS), thermoplastic elastomers (TPE);
from a minimum of 55% to a maximum of 75% by weight of the total formulation of resins chosen from: rosin resins, esterified rosin resins and other rosin derivatives, hydrocarbon resins, hydrogenated cycloaliphatic hydrocarbon resins, phenolic resins, styrene resins, or mixtures thereof;
from a minimum of 0.2% up to a maximum of 2.0% by weight of the total formulation of a mixture of stabilizers and antioxidants, wherein the quantity of stabilizers within the mixture varies from 0 up to a maximum 1.50% by weight of the total formulation and the amount of antioxidants varies from 0 up to a maximum of 1.50% by weight of the total formulation, such as in particular: primary phenolics pentaerythritol-tetrakis(3(3,5-di-tert-butyl-4-hydroxyphenyl)propionate);
from a minimum of 5% to a maximum of 35% by weight of the total formulation of paraffinic or naphthenic plasticizers;
from a minimum of 2% up to a maximum of 5% by weight of the total formulation of mineral fillers such as in particular: silica, carbon black, graphite.

A third specific object of the present invention is a tire in which the inner surface, at least in correspondence with the tread, is coated with a layer of an adhesive sealant formulation as defined above.

Preferably, according to the invention, said layer of adhesive sealant formulation is coated with a layer of sound-absorbing material and more preferably said layer of sound-absorbing material comprises expanded EVA or expanded polyethylene.

A fourth specific object of the present invention is also a method for producing a tire as defined in claims 4-6, which comprises a step of applying by hot melt extrusion, on the inner surface of said tire, at least in correspondence with the tread, a layer of an adhesive sealant formulation for tires as previously defined, preferably at a temperature of 180° C.

Furthermore, again according to the invention, said method provides a preliminary step wherein the internal surface of said tire is prepared by mechanical cleaning.

Finally, again according to the present invention, following said step of applying a layer of adhesive sealant formulation on the inner surface of said tire, it is provided a step wherein a layer of sound-absorbing material, which includes expanded EVA or expanded polyethylene, is further applied on said layer of adhesive sealant formulation for tires.

In particular, according to the invention, said layer of sound-absorbing material is applied directly on the adhesive sealant formulation layer, without the need of interposing intermediate adhesive layers or other preventive preparations.

The invention will be described below for illustrative but not limitative purposes, with particular reference to some illustrative examples.

The adhesive sealant formulation for tires according to the present invention is obtained by mixing together, in variable proportions according to the final desired characteristics, selected types of block copolymers with selected types of resins, antioxidants, and with paraffinic or naphthenic plasticizers.

By way of example, the characteristics of the adhesive sealant formulation for tires according to the present invention must be such to allow its practical use within a temperature range from −10° C. to +130° C. while maintaining its physical and mechanical characteristics unchanged when in use.

In particular, the composition of the adhesive sealant formulation for tires according to the present invention provides for the use of the following families of materials:
block copolymers, from a minimum of 20% to a maximum of 35% by weight of the total formulation, chosen from: polyisobutadiene (PIB), styrene-isoprene-styrene (SIS), styrene-butadiene-styrene (SBS), styrene-isoprene-butadiene-styrene (SIBS), styrene-ethylene-butadiene-styrene (SEBS), styrene-ethylene-propylene-styrene (SEPS), thermoplastic elastomers (TPE);
resins, from a minimum of 55% to a maximum of 75% by weight of the total formulation, chosen from: rosin resins, esterified rosin resins and other rosin derivatives, hydrocarbon resins, hydrogenated cycloaliphatic hydrocarbon resins, phenolic resins, styrene resins, or mixtures thereof;
a mixture of stabilizers and antioxidants from a minimum of 0.2% up to a maximum of 2.0% by weight of the total formulation, wherein the quantity of stabilizers within the mixture varies from 0 up to a maximum of 1.50% by weight of the total formulation and the amount of antioxidants varies from 0 up to a maximum of 1.50% by weight of the total formulation such as in particular: primary phenolics pentaerythritol-tetrakis(3(3,5-di-tert-butil-4-hydroxyphenyl)propionate);
paraffinic or naphthenic plasticizers from a minimum of 5% to a maximum of 35% by weight of the total formulation;
mineral fillers from a minimum of 2% up to a maximum of 5% by weight of the total formulation, such as in particular: silica, carbon black, graphite.

In order to satisfy the peculiar characteristics required of the adhesive sealant formulation for tires according to the present invention for its final use, the composition must respect the specified ranges. In particular, the quantity of additives (i.e. antioxidants and/or stabilizers at high temperatures) is determined according to the quantity and nature of the block copolymers used.

The choice of copolymers and resins to be used is made according to the operating temperature range to be used, choosing those with higher molecular weight and higher viscosity to increase the temperature resistance and those with low viscosity and more flexible for low temperatures, in a temperature range from −20′C to +150′C.

Furthermore, in selecting the components for the production step, in order to avoid degradation issues, the following parameter must be respected for all components: melting temperature from a minimum of 160° C. to a maximum of 180° C. Higher temperatures affect the final characteristics of the sealant product, such as the elastic modulus, the tensile strength and the adhesiveness or stickiness.

The preparation of the adhesive sealant formulation for tires according to the present invention must be done with a hot mixer and necessarily brought under vacuum to avoid the formation of air bubbles inside the mass, whose presence could cause a loss of pressure in the tire.

The processing procedure with the mixer must be established according to the raw materials used following the order indicated in the formulations attached below.

### EXAMPLES

In the following examples two particular formulations, which have been subjected to tests aimed at verifying the feasibility and effectiveness of the adhesive sealant formulation for tires according to the present invention, are specified.

TABLE 1

| Component | % by weight | Composition |
|---|---|---|
| Europrene sol 9133 | 16.67 | styrene-isoprene-styrene |
| Napis30 | 11.91 | polyisobutadiene |
| Pharma 55 | 7.94 | paraffinic oil |
| Escorez 5380 | 11.51 | hydrocarbon resin |
| Regalite 1125 | 23.82 | hydrocarbon resin (with low |
| | | melting point) |
| Pin Rosin 2683 | 11.91 | esterified rosin resin |
| Foralyn | 15.88 | hydrogenated rosin resin |
| Irganox 1010 | 0.36 | stabilizer |
| Total | 100.00 | |

TABLE 2

| Component | % by weight | Composition |
|---|---|---|
| Kraton 1163 | 13.26 | styrene-isoprene-styrene |
| Kraton 1114 | 13.26 | styrene-isoprene-styrene |
| Pharma 55 | 14.40 | paraffinic oil |
| Escorez 5380 | 10.44 | hydrocarbon resin |
| Regalite 1100 | 22.82 | hydrocarbon resin |
| Pin Rosin 2683 | 10.80 | esterified rosin resin |
| Pince Rosin 257.3 | 14.40 | esterified rosin resin |
| Irganox 1010 | 0.32 | stabilizer |
| Lowinox 22cp46 | 0.30 | antioxidant |
| Total | 100.00 | |

The adhesive sealant formulation for tires according to the present invention is presented as a rubbery mass, applicable in its molten state using a hot melt extruder system with its end part adapted to the tire profile, at a thickness of about 3 mm, by adjusting the temperature as follows: 160° C. in the melting zone (or melting tank), 180° C. at the application end (a shaped applicator).

These formulations are completely free from solvents or other volatile substances.

After the application, it is advisable to cover the applied mass with a very thin film of polyethylene or EVA, to prevent the mass, being sticky, from becoming covered with dust during the storage step of the tire.

According to an embodiment of the present invention, the adhesive sealant formulation for tires can also be prepared in the form of a preformed tape or sheet, to be subsequently applied to the tire, in this case prepared using a simple mechanical cleaning.

The relevant chemical and physical characteristics of the adhesive sealant formulation for tires according to the present invention are:
adhesion by cohesion=2 N/mm-3 N/mm
elongation=1200%±15%
elastic modulus at 100% elongation=1.5-3 kg/cm²
tensile strength=10 kg/cm²-12 kg/cm²
stickiness=1 cm as per ASTM D3121 standard
viscosity at 160° C.=5500-5700 cP
viscosity at 190′C=1150-1350 cP

Viscosity was measured with a Brookfield Thermocell viscometer, rotor 28, speed 10.

On tires fitted on a car, inside which the adhesive sealant formulation according to the present invention had been applied, it has been shown that, in the test with speed up to 150 km/h, therefore with significant centrifugal forces, there is no deformation of the applied mass of the adhesive sealant formulation for tires according to the present invention, which has kept intact its elastoplastic consistency and therefore its functionality.

Further tests carried out on tires inside which the adhesive sealant formulation according to the present invention has been applied made it possible to verify that, by inserting a nail into a tire, it remains perfectly wrapped and glued to the adhesive sealant formulation mass, preventing the air from escaping. Subsequently, by completely extracting the nail, the is adhesive sealant formulation mass glued thereto follows it, elongating until the hole is perfectly sealed and thus preventing the tire pressure loss.

It is also possible to manually apply on the mass (as per the formulation), previously applied inside a tire, a layer of sound-absorbing material, such as expanded EVA or expanded polyethylene to reduce the noise of the tire during rolling, without compromising the self-sealing characteristic. In particular, this layer of sound-absorbing material can be applied directly on the layer of adhesive sealant formulation, without the need of interposing adhesive intermediate layers or other preventive preparations.

The present invention has been described for illustrative, but not limitative, purposes, according to its preferred embodiments, but it is to be understood that variations and/or modifications may be made by those skilled in the art without thereby departing from the scope of protection, as defined by the attached claims.

1-10. (canceled)

11. An adhesive sealant formulation for tires, comprising:
from a minimum of 20% to a maximum of 35% by weight of the total formulation of block copolymers chosen from the group consisting of: polyisobutadiene (PIB),
styrene-isoprene-styrene (SIS), styrene-butadiene-styrene (SBS), styreneisoprene-butadiene-styrene (SIBS), styrene-ethylene-butadiene-styrene (SEBS), styrene-ethylene-propylene-styrene (SEPS), thermoplastic elastomers (TPE);
from a minimum of 55% to a maximum of 75% by weight of the total formulation of resins chosen from the group consisting of: rosin resins, esterified rosin resins and
other rosin derivatives, hydrocarbon resins, hydrogenated cycloaliphatic hydrocarbon resins, phenolic resins, styrene resins, or mixtures thereof;
from a minimum of 0.2% up to a maximum of 2.0% by weight of the total formulation of a mixture of stabilizers and antioxidants, wherein the quantity of stabilizers within the mixture varies from 0 up to a maximum of 1.50% by weight of the total formulation, and the amount of antioxidants varies from 0 up to a maximum of 1.50% by weight of the total formulation;
from a minimum of 5% up to a maximum of 35% by weight of the total formulation of paraffinic or naphthenic plasticizers; and
from a minimum of 2% up to a maximum of 5% by weight of the total formulation of mineral fillers.

12. The adhesive sealant formulation for tires according to claim 11, wherein the melting temperature of the entire mass of the complete formulation is between a minimum of 160° C. and a maximum of 180° C.

13. A method for producing an adhesive sealant formulation for tires as defined in claim 11, further comprising hot mixing the following components, at a temperature comprised between 160° C. and 180° C. and under vacuum:
from a minimum of 20% to a maximum of 35% by weight of the total formulation of block copolymers chosen from the group consisting of: polyisobutadiene (PIB), styrene-isoprene-styrene (SIS), styrene-butadiene-styrene (SBS), styreneisoprene-butadiene-styrene (SIBS), styrene-ethylene-butadiene-styrene (SEBS), styrene-ethylene-propylene-styrene (SEPS), thermoplastic elastomers (TPE);
from a minimum of 55% to a maximum of 75% by weight of the total formulation of resins chosen from the group consisting of: rosin resins, esterified rosin resins and
other rosin derivatives, hydrocarbon resins, hydrogenated cycloaliphatic hydrocarbon resins, phenolic resins, styrene resins, or mixtures thereof;
from a minimum of 0.2% up to a maximum of 2.0% by weight of the total formulation of a mixture of stabilizers and antioxidants, wherein the quantity of stabilizers within the mixture varies from 0 up to a maximum of 1.50% by weight of the total formulation and the amount of antioxidants varies from 0 up to a maximum of 1.50% by weight of the total formulation;
from a minimum of 5% up to a maximum of 35% by weight of the total formulation of paraffinic or naphthenic plasticizers;
from a minimum of 2% up to a maximum of 5% by weight of the total formulation of mineral fillers.

14. A tire, wherein the inner surface, at least in correspondence with the tread, is coated with a layer of an adhesive sealant formulation as defined in claim 11.

15. The tire according to claim 14, wherein said adhesive sealant formulation layer is coated with a layer of sound-absorbing material.

16. The tire according to claim 15, wherein said layer of sound absorbing material comprises expanded EVA or expanded polyethylene.

17. A method for producing a tire as defined in claim 14,
comprising a step of applying by hot melt extrusion, on the inner surface of said tire, at least in correspondence with the tread, a layer of an adhesive sealant formulation for tires comprising —from a minimum of 20% to a maximum of 35% by weight of the total formulation of block copolymers chosen from the group consisting of: polyisobutadiene (PIB),
styrene-isoprene-styrene (SIS), styrene-butadiene-styrene (SBS), styreneisoprene-butadiene-styrene (SIBS), styrene-ethylene-butadiene-styrene (SEBS), styrene-ethylene-propylene-styrene (SEPS), thermoplastic elastomers (TPE);
from a minimum of 55% to a maximum of 75% by weight of the total formulation of resins chosen from the group consisting of: rosin resins, esterified rosin resins and
other rosin derivatives, hydrocarbon resins, hydrogenated cycloaliphatic hydrocarbon resins, phenolic resins, styrene resins, or mixtures thereof;
from a minimum of 0.2% up to a maximum of 2.0% by weight of the total formulation of a mixture of stabilizers and antioxidants, wherein the quantity of stabilizers within the mixture varies from 0 up to a maximum of 1.50% by weight of the total formulation, and the amount of antioxidants varies from 0 up to a maximum of 1.50% by weight of the total formulation;
from a minimum of 5% up to a maximum of 35% by weight of the total formulation of paraffinic or naphthenic plasticizers; and
from a minimum of 2% up to a maximum of 5% by weight of the total formulation of mineral fillers.

18. The method according to claim 17, wherein said step of applying by hot melt extrusion takes place at a temperature of 180° C.

19. The method according to claim 17, wherein before said step of applying by hot melt extrusion, the method further comprises a step of preparing the inner surface of said tire by mechanical cleaning.

20. The method according to claim 17, wherein after said step of applying on the inner surface of said tire a layer of an adhesive sealant formulation for tires, the method further comprises a step of applying on said layer of adhesive sealant formulation for tires a layer of sound-absorbing material, which includes expanded EVA or expanded polyethylene.
